(19) United States
(12) Patent Application Publication
(10) Pub. No.: US 2021/0019427 A1
(43) Pub. Date: Jan. 21, 2021

(54) CACHE MEMORY DATA BLOCK ENCRYPTION

(71) Applicant: Seagate Technology LLC, Cupertino, CA (US)

(72) Inventors: Dieter P. SCHNABEL, Erie, CO (US); Richard O. WEISS, Superior, CO (US); Andrew C. HARDWICK, Longmont, CO (US)

(73) Assignee: Seagate Technology LLC

(21) Appl. No.: 16/514,799

(22) Filed: Jul. 17, 2019

(51) Int. Cl. G06F 21/60; G06F 21/79; G06F 12/0802

(52) U.S. Cl. CPC G06F 21/602; G06F 2212/60; G06F 12/0802; G06F 21/79

(57) ABSTRACT

A system that includes a cache memory, a counter, an encryption unit, and a logic block. The cache memory is configured to generate a plurality of data blocks. The cache memory outputs the plurality of data blocks responsive to a trigger signal. The counter unit is configured to generate a first plurality of nonrepeating data at a first instance in time. The logic block configured to perform a logic operation between a subset data blocks of the plurality of data blocks, received from the cache memory, and the first plurality of nonrepeating data in parallel, wherein the logic block is configured to generate a first logic data output. The encryption unit configured to encrypt the first logic data output using a first key.

### SUMMARY

Provided herein is a system that includes a cache memory, a counter, an encryption unit, and a logic block. The cache memory is configured to generate a plurality of data blocks. The cache memory outputs the plurality of data blocks responsive to a trigger signal. The counter unit is configured to generate a first plurality of nonrepeating data at a first instance in time. The encryption unit is configured to encrypt the first plurality of nonrepeating data with a first key to generate encrypted first plurality of nonrepeating data. The logic block is configured to encrypt a subset data blocks of the plurality of data blocks, received from the cache memory, with the encrypted first plurality of nonrepeating data in parallel.

These and other features and advantages will be apparent from a reading of the following detailed description.

### BRIEF DESCRIPTION OF DRAWINGS

FIG. 1 shows a system for encrypting data blocks of a cache memory responsive to a triggering event according to one aspect of the present embodiments.

FIGS. 2A-2C show illustrative example of a system for encrypting data blocks of a cache memory according to one aspect of the present embodiments.

FIG. 3 shows an illustrative method for encrypting data blocks of a cache memory responsive to a triggering event according to one aspect of the present embodiments.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device or a processor. It has proven convenient at times, principally for reasons of common usage, to refer to these signals as transactions, bits, values, elements, symbols, characters, samples, pixels, or the like.

Although the diagrams depict components as functionally separate, such depiction is merely for illustrative purposes. It will be apparent that the components portrayed in these figures can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “decrypting,” “encrypting,” “processing,” “updating,” “instantiating,” “performing,” “outputting” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Data blocks from cache memory may need to be stored in a memory component, e.g., flash memory device, in response to certain events, e.g., power failure, etc. For example, data blocks may need to be stored in a nonvolatile cache memory in response to a triggering signal indicating detection of a power failure. This may be referred to as cache flush. Conventionally, the data blocks from the cache memory being stored in a nonvolatile memory responsive to a power failure is unencrypted. However, content of the flash memory or other memory components storing the data blocks from cache memory may be compromised and therefore pose a security risk. For example, flash memory is removable and as a result its content may be compromised.

Accordingly, it is desirable to protect the data being stored by encrypting the data blocks of the cache memory. It may be advantageous to encrypt the blocks of data, from the cache memory, as it is being stored in a nonvolatile memory. It is appreciated that in some embodiments, a counter mode encryption may be utilized to encrypt cache data blocks during a cache flush. As such, cache data blocks are being encrypted, in parallel, as they are being stored in a nonvolatile memory component.

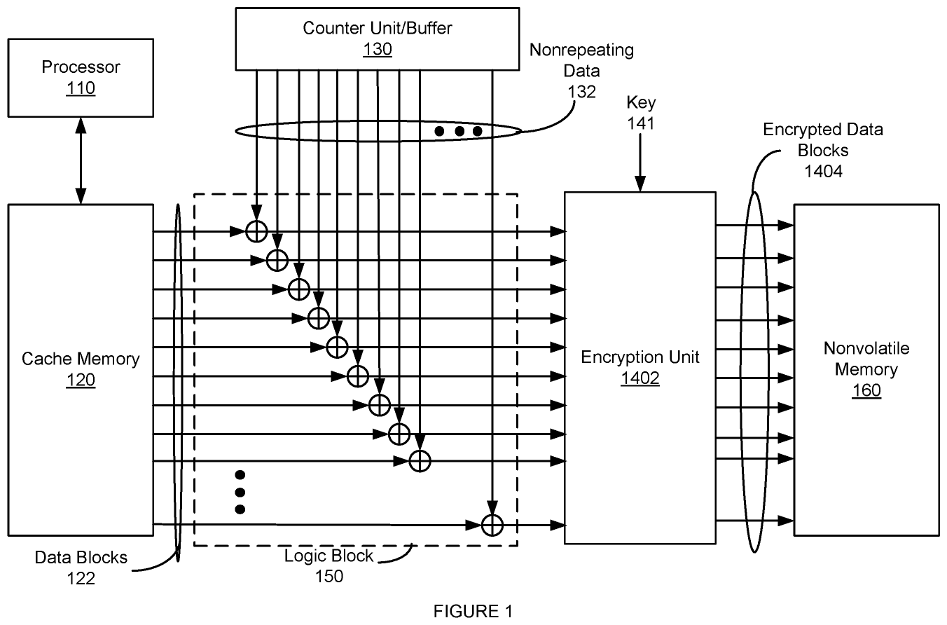

Referring now to FIG. 1, a system for encrypting data blocks of a cache memory responsive to a triggering event according to one aspect of the present embodiments is shown. A processor 110 is coupled to a cache memory 120. The cache memory 120 may be integrated into the processor 110 in some embodiments. The cache memory 120 may store programming instructions and data. As the processor 110 executes instructions, additional blocks of data may be generated and stored in the cache memory 120. It is appreciated that under certain conditions, e.g., power failure, the content of the cache memory 120 may be stored for later retrieval. For example, in response to a triggering signal determining that a power failure has occurred or is about to occur, the content may be stored in a nonvolatile memory. The storing of content of the cache memory 120 may be known as cache flush. It is appreciated that in order to protect the content, the blocks of data from the cache memory 120 may be encrypted.

It is appreciated that in some embodiments, a counter/buffer 130 may generate and store nonrepeating data 132. For example, the nonrepeating data may have values that are incremented. In other examples, the nonrepeating data being generated by a function that generates nonrepeating values, e.g., random values. In some embodiments, a random value may be combined with to incremental values to create nonrepeating values. In some embodiments, the nonrepeating data 132 is generated in response to a triggering signal to initiate the cache flush.

It is appreciated that no overlap of values may occur for the generated nonrepeating data at a first instance in time and a second instance in time unless a predetermined threshold period is expired. For example, at time t₁ a first set of nonrepeating data may be created and at t₂ a second set of nonrepeating data may be created. As long as t₁−t₂<predetermined threshold period, then no values overlap between the first set and the second set of nonrepeating data but after the predetermined threshold period an overlap may occur.

It is appreciated that in some embodiments, the counter may be a 128 bit counter. It is further appreciated that nonrepeating data generated by the counter may be stored in a buffer with a manageable size, e.g., 1 MB or less. It is also appreciated that while the counter/buffer 130 are shown as an integrated unit, they may be implemented as two separate units and the integrated embodiment is for illustrative purposes only and should not be construed as limiting the scope of the embodiments.

It is appreciated that the nonrepeating data 132 is input to the logic block 150 where a logical operation is performed on data blocks 122. The logic block 150 also receives the blocks of data 122 from the cache memory 120 during cache flush. The cache memory 120 outputs blocks of data when it receives a triggering signal initiating the cache flush and the triggering signal may be generated in response to a particular event, e.g., power failure, etc. The logic block 150 may include one or more exclusive OR (XOR) logic blocks. It is appreciated that discussion of the operation with respect to XOR logic blocks is for illustrative purposes only and should not be construed as limiting the scope of the embodiments. The logic block 150 performs a logic operation, e.g., XOR, on the received data blocks 122 and the nonrepeating data 132 in parallel. The result of the logic block 150 is input into an encryption unit 1402.

The encryption unit 1402 encrypts the received data from the logic block 150 using key 141. The encryption unit 1402 may perform an advanced encryption standard (AES) operation on the nonrepeating data 132. It is appreciated that discussion of the AES operation is for illustrative purposes only and should not be construed as limiting the scope of the embodiments. For example, other data encryptions such as data encryption standard (DES), Rivest-Shamir-Adleman (RSA), etc., may be used. The encryption unit 1402 outputs the encrypted data blocks 1404 for storage in the nonvolatile memory 160.

It is appreciated, that a similar process may be repeated if there remain additional data blocks that are unencrypted. For example, for additional data blocks, a second set of nonrepeating data is generated by the counter at a second instance in time. The additional data blocks are logically operated on using a second set of nonrepeating data. The output of the logical operation is encrypted by the same key 141 or it may be encrypted by a different key in some embodiments. The result may be stored in the nonvolatile memory 160. It is appreciated that the process may similarly be repeated until all of the data blocks from the cache memory 120 is stored in the encrypted format. It is appreciated that the number of components, e.g., number XORs, number of nonrepeating data, etc., is for illustrative purposes only and should not be construed as limiting the scope of the embodiments.

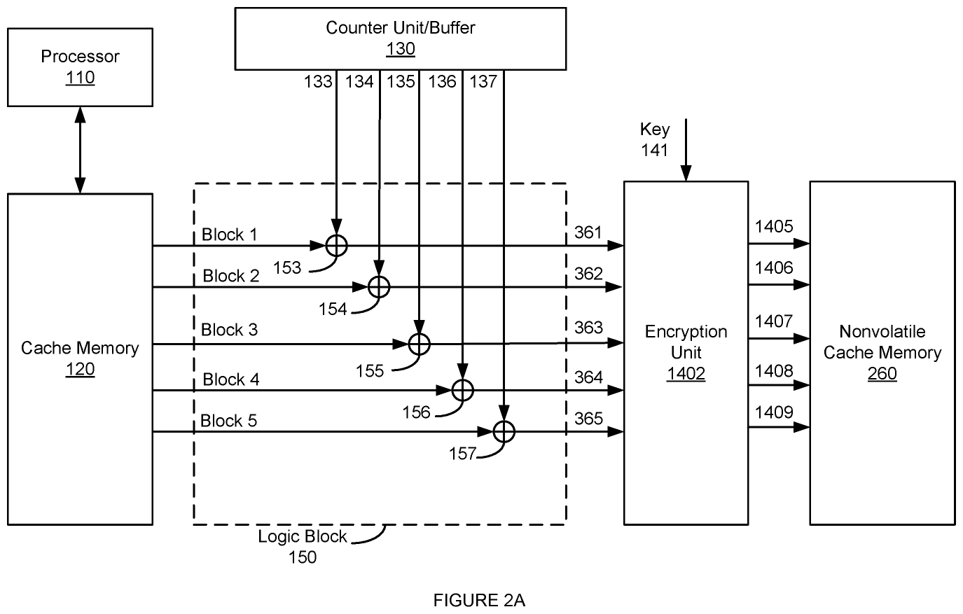

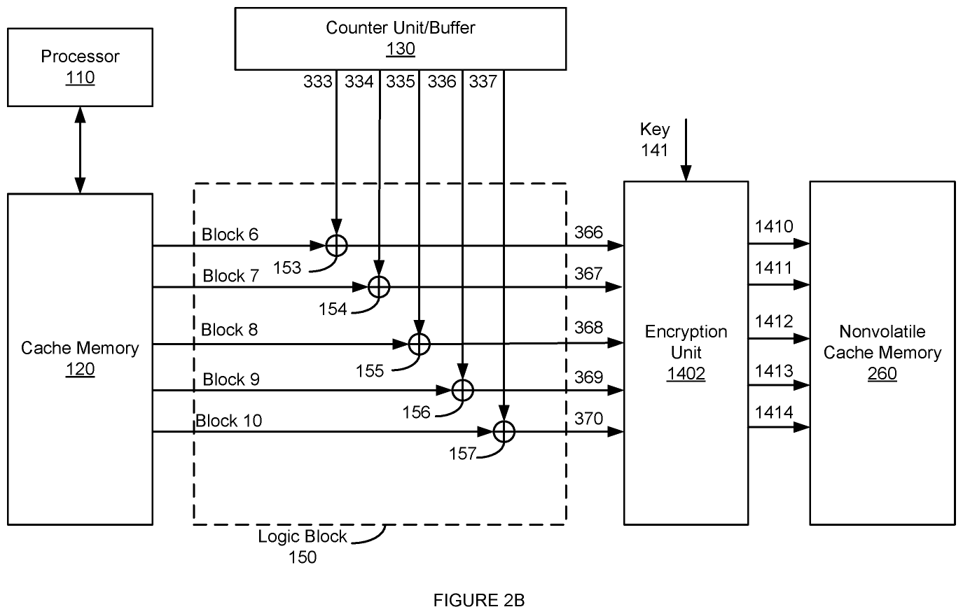

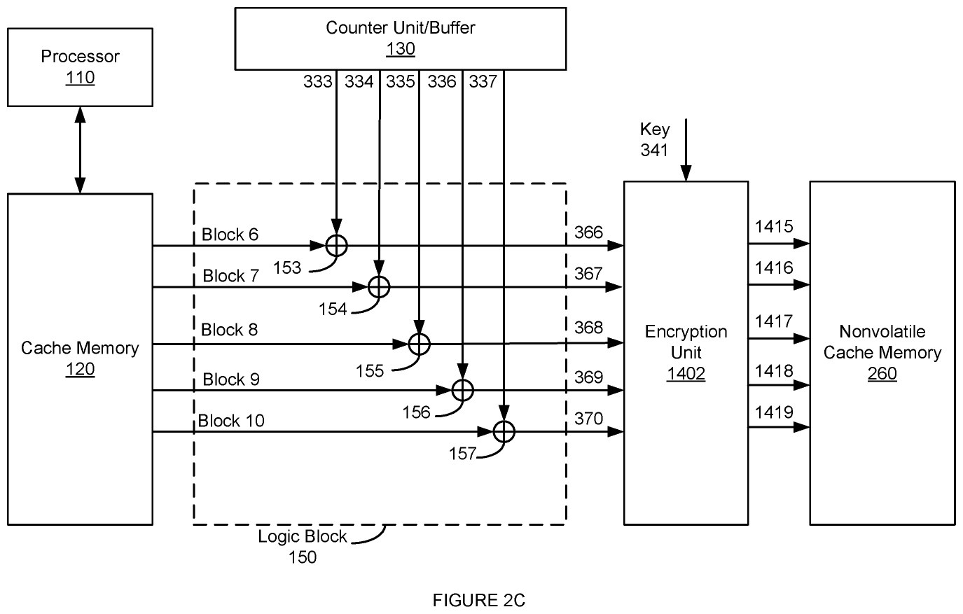

Referring now to FIGS. 2A-2C, illustrative example of a system for encrypting data blocks of a cache memory according to one aspect of the present embodiments is shown. Referring specifically to FIG. 2A, encryption and storing of data blocks at a first instance in time is shown. At a first instance in time, e.g., t₁, a power failure may be detected and a triggering signal may be generated to initiate a cache flush. As such, data blocks, e.g., blocks 1-5, from the cache memory 120 is input into the logic block 150 in parallel. Similarly, the counter unit/buffer 130 generate and transmit nonrepeating data 133-137 to the logic block 150 where logical operation is performed. In other words, the XOR components 153-157 of the logic bock 150 are used to generate a logic outputs 361-365 from the nonrepeating data 133-137 and the data blocks 1-5, in parallel. The logic outputs 361-365 are input into the encryption unit 1402. The encryption unit 1402 encrypts the logic outputs 361-365 using key 141 in order to generate encrypted data blocks 1405-1409 for storage in the nonvolatile cache memory 260 that operates substantially similar to nonvolatile memory 160 of FIG. 1.

Referring now to FIG. 2B, the process as described in FIG. 2A is repeated for additional data blocks of the cache memory 120 that remain unencrypted and not stored. For example, blocks 6-10 are output in parallel from the cache memory 120 to the logic block 150. Similarly, additional nonrepeating data 333-337 are generated and transmitted from the counter unit/buffer 130 to the logic block 150 to generate logic outputs 366-370. In other words, the logic block 150 performs a logical operation on blocks 6-10 and the nonrepeating data 333-337, in parallel, in order to generate logic outputs 366-370. The logic outputs 366-370 are transmitted to the encryption unit 1402 to be encrypted with key 141. The encrypted data blocks 1410-1414 are subsequently transmitted to the nonvolatile cache memory 260 for storage thereof. It is appreciated that process as described in FIGS. 2A-2B may be repeated until the remainder of the data blocks are encrypted and stored.

Referring now to FIG. 2C, an alternative process as described in FIG. 2B is shown. FIG. 2C is substantially similar to FIG. 2B except that a different key is used by the encryption unit 140 every time that new nonrepeating data is being encrypted. For example, key 341, that is different from key 141, may be used to encrypt the logic outputs 366-370. As such, a different set of encrypted data blocks is created in comparison to FIG. 2B. For example, encrypted data blocks 1415-1419 are generated and stored in the nonvolatile cache memory 260.

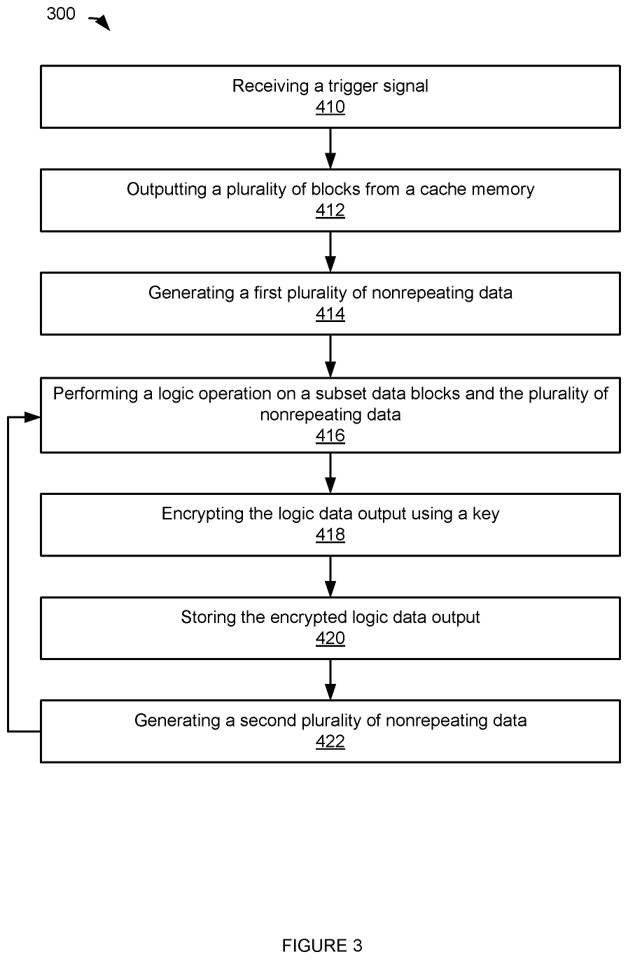

Referring now to FIG. 3, an illustrative method for encrypting data blocks of a cache memory responsive to a triggering event according to one aspect of the present embodiments is shown. At step 410, a trigger signal is received. The trigger signal may be generated responsive to an event occurring, e.g., detecting a power failure, etc. As described above, the trigger signal may initiate a cache flush process. Accordingly, at step 412, a plurality of blocks from a cache memory is output. At step 414, a first plurality of nonrepeating data is generated. At step 416, a logical operation, e.g., XOR operation, may be performed on a subset data blocks of the plurality of data blocks and the first plurality of nonrepeating data to generate a logic output. The logic output is encrypted using a key, at step 418. At step 420, the encrypted data is stored, e.g., in a nonvolatile memory. In some embodiments, any data blocks of the plurality of data blocks that remains unencrypted and not stored by the nonvolatile memory goes to the process until all data blocks of the plurality of data blocks are encrypted and stored. As such, at step 422, a second plurality of nonrepeating data is generated. The process continues to step 416, where logical operation is performed on another subset data blocks of the plurality of data blocks and the second plurality of nonrepeating data. The process continues to step 418 where in some embodiments the same key as before is used to encrypt the another subset data blocks. However, it is appreciated that in some alternative embodiments, a key that is different from the previous key may be used to encrypt the another subset data blocks. The process continues until all data blocks of the cache memory are encrypted and subsequently stored in a nonvolatile memory.

Accordingly, data blocks of the cache memory are encrypted in parallel as they are stored in a nonvolatile memory. Thus, content of the cache is protected from being compromised and stored efficiently for later retrieval.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A system comprising:
a cache memory configured to generate a plurality of data blocks, wherein the cache memory outputs the plurality of data blocks responsive to a trigger signal;
a counter unit configured to generate a first plurality of nonrepeating data at a first instance in time;
a logic block configured to perform a logic operation between a subset data blocks of the plurality of data blocks, received from the cache memory, and the first plurality of nonrepeating data in parallel, wherein the logic block is configured to generate a first logic data output; and
an encryption unit configured to encrypt the first logic data output using a first key.

2. The system as described in claim 1, wherein the trigger signal is generated responsive to an event failure.

3. The system as described in claim 1, wherein the counter is configured to generate a second plurality of data at a second instance in time, wherein overlap of a value of a nonrepeating data within the first plurality of nonrepeating data and the second plurality of nonrepeating data is permitted if the difference between the second instance in time and the first instance in time is greater than a given period of time.

4. The system as described in claim 3, wherein the logic block is further configured to perform another logic operation between another subset data blocks of the plurality of data blocks, received from cache memory, and the second plurality of nonrepeating data in parallel, wherein the logic block is configured to generate a second logic data output, and wherein the encryption unit is configured to encrypt the second logic data output with the first key.

5. The system as described in claim 3, wherein the logic block is further configured to perform another logic operation between another subset data blocks of the plurality of data blocks, received from cache memory, and the second plurality of nonrepeating data in parallel, wherein the logic block is configured to generate a second logic data output, and wherein the encryption unit is configured to encrypt the second logic data output with a second key.

6. The system as described in claim 1, wherein the logic block comprises an exclusive OR (XOR) gate.

7. The system as described in claim 2 further comprising:
a nonvolatile memory configured to store encrypted data output from the encryption unit; and
a buffer configured to store the first plurality of nonrepeating data.

8. The system as described in claim 2, wherein the counter unit is a 128-bit counter.

9. A method comprising:
receiving a trigger signal;
responsive to the trigger signal, outputting a plurality of data blocks from a cache memory;
generating a first plurality of nonrepeating data at a first instance in time;
performing a logic operation between a subset data blocks of the plurality of data blocks, received from the cache memory, and the first plurality of nonrepeating data in parallel to generate a first logic data output; and
encrypting the first logic data output using a first key.

10. The method as described in claim 9 further comprising:
generating a second plurality of nonrepeating data at a second instance in time;
performing another logic operation between another subset data blocks of the plurality of data blocks, received from the cache memory, and the second plurality of nonrepeating data in parallel to generate a second logic data; and
encrypting the second logic data output using the first key.

11. The method as described in claim 9 further comprising:
generating a second plurality of nonrepeating data at a second instance in time;
performing another logic operation between another subset data blocks of the plurality of data blocks, received from the cache memory, and the second plurality of nonrepeating data in parallel to generate a second logic data; and
encrypting the second logic data output using a second key.

12. The method as described in claim 9 further comprising storing the encrypted first logic data.

13. The method as described in claim 9, wherein the logical operation is an exclusive OR (XOR) operation.

14. The method as described in claim 9, wherein the trigger signal is generated responsive to an event failure.

15. A system comprising:
a cache memory configured to generate a plurality of data blocks, wherein the cache memory outputs the plurality of data blocks responsive to a trigger signal;
a buffer configured to receive a first plurality of nonrepeating data at a first instance in time;
a logic block configured to perform a logic operation between a subset data blocks of the plurality of data blocks, received from the cache memory, and the first plurality of nonrepeating data in parallel, wherein the logic block is configured to generate a first logic data output; and
an encryption unit configured to encrypt the first logic data output using a first key.

16. The system as described in claim 15, wherein the trigger signal is generated responsive to an event failure.

17. The system as described in claim 15, wherein the buffer is configured to receive a second plurality of data at a second instance in time, wherein overlap of a value of a nonrepeating data within the first plurality of nonrepeating data and the second plurality of nonrepeating data is permitted if the difference between the second instance in time and the first instance in time is greater than a given period of time.

18. The system as described in claim 17, wherein the logic block is further configured to perform another logic operation between another subset data blocks of the plurality of data blocks, received from cache memory, and the second plurality of nonrepeating data in parallel, wherein the logic block is configured to generate a second logic data output, and wherein the encryption unit is configured to encrypt the second logic data output with the first key.

19. The system as described in claim 17, wherein the logic block is further configured to perform another logic operation between another subset data blocks of the plurality of data blocks, received from cache memory, and the second plurality of nonrepeating data in parallel, wherein the logic block is configured to generate a second logic data output, and wherein the encryption unit is configured to encrypt the second logic data output with a second key.

20. The system as described in claim 15, wherein the logic block comprises an exclusive OR (XOR) gate.
